(19) United States
(12) Patent Application Publication
(10) Pub. No.: US 2003/0055659 A1
(43) Pub. Date: Mar. 20, 2003

(54) Method and system for facilitating product development processes

(75) Inventor: Eric R. Alling, Upton, MA (US)

Correspondence Address: Dike, Bronstein, Roberts & Cushman, Intellectual Property Practice Group, EDWARDS & ANGELL, P.O. Box 9169, Boston, MA, 02209, US

(73) Assignee: Shipley Company, L.L.C., Marlborough, MA

(21) Appl. No.: 09/837,699

(22) Filed: Aug. 2, 2001

(51) Int. Cl. G06F 15/16; G06F 17/00

(52) U.S. Cl. 705/1; 707/104.1

(57) ABSTRACT

An exemplary embodiment of the invention relates to a computer-based system and method for facilitating product development processes within a multi-enterprise environment via a computer network, said multi-enterprise environment including a product development enterprise and at least one customer enterprise, a research and development organization, and a marketing enterprise, all in communication via the Internet or suitable extranet connections. Utilizing the product specification and development application of the present invention, a customer accesses a web site of said product development enterprise, accesses its account, provides data inputs pertaining to a product development request, whereby the product development enterprise extracts said data inputs for review and analysis, establishes a product development plan in response to said review and said analysis, and executes said product development plan. Changes to the product development plan may be made throughout the product development cycle in order to accommodate new technology, processes, and requirements.

The product development enterprise system comprises a host system operating a web server, an applications server, and a database manager; a data storage device in communication with the host system, and at least one terminal for accessing the host system. The system runs on a network that is coupled to the Internet and is accessible to a customer enterprise system identified with proper permissions. The applications server executes a set of programs for managing the product development enterprise system, including the product specification and development application of the present invention.

### BACKGROUND OF THE INVENTION

The present invention relates generally to product development processes. More particularly, the present invention relates to an enhanced method and system for facilitating new product development among business partners in a multi-enterprise environment.

Conventional product development and planning systems such as Enterprise Resource Planning (ERP), Material Requirements Planning (MRP) and Advanced Planning and Scheduling (APS) are well known in many industries today as useful methods for managing enterprise operations. ERP systems provide a framework that integrates all facets of a business, including planning, manufacturing, supply chain management, sales and marketing. Common ERP software vendors such as SAP(TM), Oracle(TM), Baan(TM), and Peoplesoft(TM) are enabling businesses to implement these systems using computers. Traditional Material Requirements Planning (MRP) and Manufacturing Resource Planning systems generate requirements for materials, parts, and subassemblies that are established on an organization's Bills of Material (BOMs) for the manufacture of existing products.

With the advent of the Internet and related technology, more complex planning systems have evolved that allow two or more disparate and/or geographically independent businesses to interact with one another via a combination of network-based hardware and software solutions. Based on common communication protocols and common standards for system interoperability, the Internet provides a ubiquitous message routing architecture that supports reliable inter-business connectivity around the world. Further, the Internet and related intranet and extranet technologies offer a relatively low cost of entry, making them practical for use by not only the largest manufacturing enterprises, but also the smallest supplier enterprises. To alleviate related web-based security issues, companies have created two separate networks: an intranet that connects the internal processes to the applications and data they need and an extranet that connects external processes to the applications and data they need. These companies then add firewalls or security devices to protect against unauthorized access to the internal network and to isolate unauthorized Internet access from the extranet.

Effective product development and planning systems are particularly important to the electronics industry. In today's global economy, particularly with respect to computer technology, life cycles and prices related to electronics such as personal computers, PDAs, cellular telephones, etc., have dramatically declined over the last ten years. Further, the growth of e-commerce on the Internet creates additional pressures on this industry as traditional geographic barriers are broken down and new businesses/competitors are entering the market. Increasing customer demands for higher levels of quality and service, coupled with unique customization requirements and product configurations are not likely to drop off any time soon. In order to stay competitive, these market dynamics require industries to develop and introduce new products faster and cheaper than the competition. To meet this demand, new and enhanced business solutions are critical.

In one solution, manufacturers and suppliers are forming what are known as virtual corporations (or extended enterprises) whereby each entity within the network specializes in a particular area and, together, operate as one organization or business with respect to the products being produced. In order for these separate entities to effectively operate as one, they must be able to synchronize and share information and fully integrate their existing business processes. Information shared, such as product descriptions, process technologies, market research data, testing results, etc., must be complete, accurate and up-to-date. Additionally, architectures and applications based on open standards are required in order for complete collaboration within and among business partners to occur. Few existing applications provide integrated new product development solutions and none of these provide complete, synchronized collaboration abilities.

Major breakthroughs in technology can yield entirely new products and processes. Exploiting these breakthroughs requires patience, time, and perseverance between technological researchers and market developers throughout the development process.

A process is therefore desirable which can improve the existing product development and planning processes in a multi-enterprise environment.

### BRIEF SUMMARY OF THE INVENTION

An exemplary embodiment of the invention relates to a computer-based system and method for facilitating product development functions in a network environment. The system includes a product development enterprise system comprising a host system operating a web server, an applications server, and a database manager; a data storage device in communication with the host system, and at least one terminal for accessing the host system. The product development enterprise system runs on a network that is coupled to the Internet and is accessible to a customer enterprise system identified with proper permissions. The applications server executes a set of programs for managing the product development enterprise system, including the product specification and development tool of the present invention. Product specifications, specification changes and modifications, industry standards are some of the items inputted into the product specification and development database via the tool where regular extractions occur and analysis and calculations are performed on the inputs.

### BRIEF DESCRIPTION OF THE DRAWINGS

The present invention is described below with reference to the following drawing figures of which:

FIG. 1 is a block diagram of a portion of a network system on which the product specification and development application is executed in an exemplary embodiment of the present invention; and

FIG. 2 is a flowchart describing the product specification and development process as implemented by the product specification and development tool.

### DESCRIPTION OF THE PREFERRED EMBODIMENT

The product specification and development tool of the present invention facilitates new product development processes which aids in streamlining the design and product development processes. It provides continuously updated information through a virtual collaborative environment to key design, management, research, and manufacturing personnel throughout the product development cycle, enabling them to make instant and sometimes critical business decisions. New products with longer gestation cycles are particularly benefitted by the product specification and development tool in that necessary modifications can be made early on in the process allowing for fewer delays and faster time-to-market. For example, a customer conveys a need for a new product which is likely to take several months or even years to be developed. During the product's development, new technology or increased restrictions caused by new industry standards now requires that the specifications for the new product be modified. Alternatively, unique properties of a particular product may open the door to new uses which shift the course of the product's development and cycle. This information can be provided by various sources and accessed instantly for quick decision making capabilities. Sources of information include collaborative support by research and development organizations, existing customers, and the product development team. The product specification and development tool allows the customer to access the product specification and development database and enter new specifications. Key personnel of management periodically extract this information, collaborate with any relevant or affected parties, and initiate whatever changes are required in response to this information. The product specification and development tool provides a central repository of various data pertaining to customer accounts, industry standards, and reports which allows the product developer to better plan its product development processes, identify cost savings opportunities and make instant business decisions before and throughout its product development cycle. The product specification and development tool enables a product developer to create an expansive view of its customer's requirements, including product specifications, quantities, customized requirements across the board in order to gain a complete picture of its product development agenda. This information enables the product developer to develop a comprehensive product development plan that is fully operable and editable upon changing requirements and circumstances. The product specification information is placed on the product developer's web site by its authorized customers and is extracted by the product developer periodically where modifications may be made throughout the products life cycle.

The following illustrates the structural and operational aspects of the present invention:

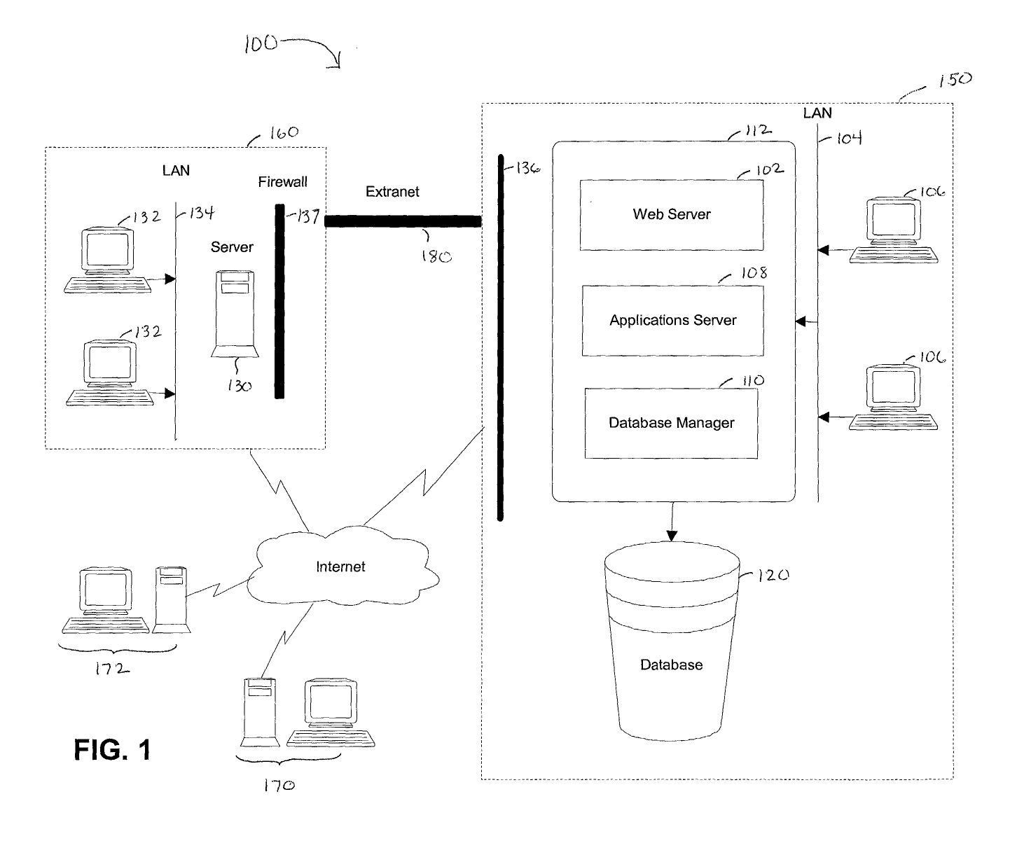

In terms of structure, reference is now made to FIG. 1. Therein depicted is a block diagram representing a network system 100 for implementing the Product specification and development tool of the present invention. System 100 includes a product development enterprise 150 comprising a web server 102 that is located on host system 112 and connected through a network 104 to terminals 106. Network 104 may comprise a LAN, a WAN or other network configuration known in the art. Further, network 104 may include wireless connections, radio based communications, telephony based communications, and other network-based communications. Applications server 108 and database manager 110 are also located on host system 112 and are in communication with web server 102 and network 104. Any web server software or similar program that handles general communications protocols and transport layer activities could be used as appropriate for the network protocol in use. A firewall 136 or other security device limits access to product development enterprise 150 to network users with proper authorization.

Host system 112 may be a mainframe or other suitable computer system. Host system 112 is running suitable web server software designed to accommodate various forms of communications, including voice, video, and text. Applications server 108 executes the Product specification and development tool of the present invention. The Product specification and development application may be one of many business applications employed by product development enterprise 150 which, in combination, constitute its Enterprise Resource Planning and Materials Requirements Planning suites described above.

Data storage device 120 is any form of mass storage device configured to read and write database type data maintained in a file store (e.g., a magnetic disk data storage device). Of course, it will be appreciated that data storage device 120 may be one that consists of multiple disk sub-systems which may be geographically dispersed and coupled via network architecture. There is no positive requirement that data storage device 120 be maintained in one facility; to the contrary, the volume of information stored therein may dictate geographical dispersion and the like. All that is required is that data storage device 120 be logically addressable as a consolidated data source across a distributed environment such as a network system. The implementation of local and wide-area database management systems to achieve the functionality of data storage device 120 will be readily understood by those skilled in the art. Information stored in data storage device 120 is retrieved and manipulated by database manager 110.

Data storage device 120 provides a repository for a library of documents and data created and utilized by the Product specification and development tool. Documents stored in data storage device 120 include customer accounts, product specifications, relevant industry standards, product development plans, product specification updates and statuses, as well as reporting features.

Customer enterprise 160 comprises web server 130 that connects terminals 132 to intranet 134 and to the Internet. Firewall 137 provides security and protection against unauthorized access to internal network information from outside sources as well as controlling the scope of access to product development enterprise system's 150 data. Terminals 132 may access web server 130 via internal web browsers located on terminals 132 (not shown). Customer enterprise 160 may be an existing or prospective trading partner of product development enterprise 150 and may be a supplier, contract manufacturer, or other value added reseller. Customer enterprise 160 may communicate via the Internet or via an extranet connection 180 with product development enterprise 150. Customer enterprise 160 accesses data relating to its own account through the use of password and identification procedures employed by product development enterprise 150. Further, customer enterprise 160 is able to provide inputs concerning its product specifications, including modifications to existing development plans and/or specifications criteria.

Also included in system 100 is research organization 170 which is in communication with product development enterprise 150 via the Internet. Research organization 170 may be a nonprofit research center or independent corporate research organization which provides data pertaining to recent advancements in technology, engineering, chemistry, and the like which is of interest to product development enterprise 150. Research organization 170 may also maintain an account with product development enterprise 150, although it is not necessary to achieve the advantages of the invention.

Enterprise 172 represents any other collaborative business partner of product development enterprise 150 which maintains communications for the purpose of providing useful information such as market research updates, competitor analysis, and any other relevant data. Enterprise 172 may have an account with product development enterprise 150. Data exchange between enterprises 150, 160, 170 and 172 is facilitated by non-proprietary eXtensible Markup Language (XML) standards where data formats and/or applications used by these enterprises are incompatible. For example, initiatives such as CIDX(TM), Chemical Industry Data Exchange, have developed new chemical e-standards for business-to-business data exchange for the chemical industry. Many leading chemical companies, marketplaces and services providers have adopted this standard. Likewise, comparable standards have also been adopted by other industries as well.

The Product specification and development tool of the present invention is an e-business application that provides continuously updated information through a virtual collaborative environment to key design, management, research, and manufacturing personnel throughout the product development cycle, enabling them to make instant and sometimes critical business decisions.

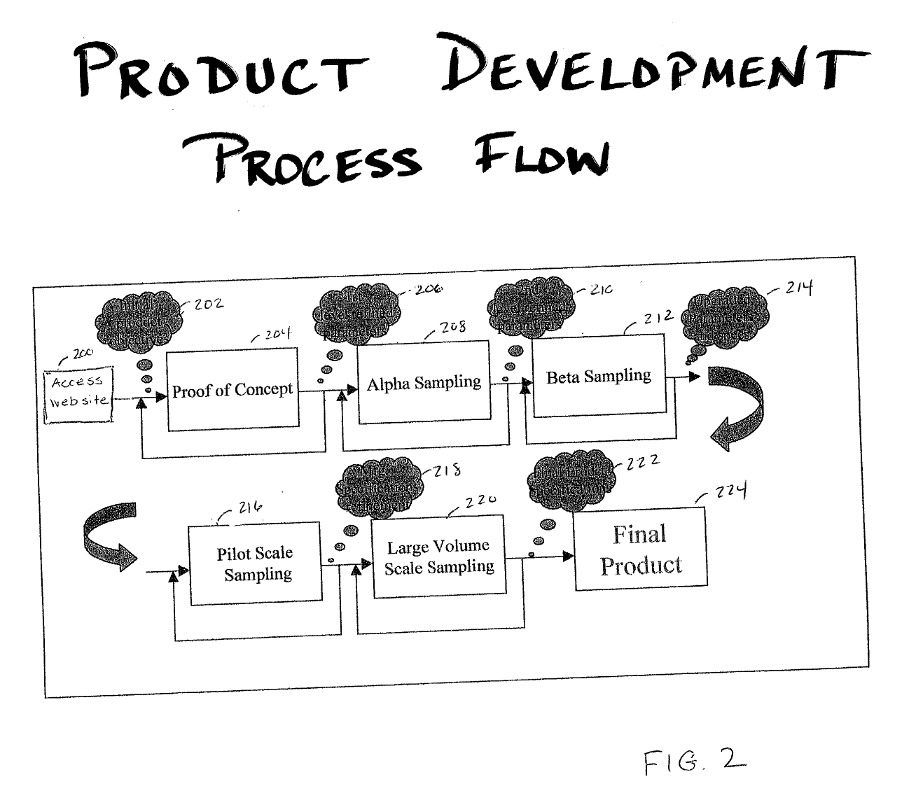

FIG. 2 illustrates the process of new product development as implemented by the product specification and development tool. A customer accesses the product developer's web site and logs on via an account identification and password at step 200. The customer enters fields of information relating to the product to be developed along with any specifications required at step 202. This information is stored in data storage device 120 and later reviewed by the product developer at enterprise 150 at step 204 whereby analysis by key development team personnel occurs. These development team personnel have access to this information via the product specification and development tool and are able to evaluate and provide inputs as necessary at step 206. Inputs provided may prompt management personnel of enterprise 150 to determine which planning procedures and business processes to be employed. Upon completion of review, further extractions from data storage device 120 may provide additional inputs from customer 160 or collaborative partners 170 and 172 of product development enterprise 150 which causes further refinements in the process to be initiated. At step 208, alpha sampling of the product occurs, whereby the product development team tests random samples of the product to ensure quality and performance standards are met. If the testing reveals deficiencies during alpha sampling, further modifications are made at step 210. The process then reverts back to step 208 where alpha sampling is performed once again. Beta sampling occurs at step 212 whereby samples of the product are presented to the customer for approval. The customer may conduct its own testing or may visually inspect the product before approval. If the product is shown to be deficient, modifications are again made to the specifications or process technology used at step 214. The process reverts back to step 212 where beta sampling occurs once again. Once Beta sampling is successful, pilot scale sampling begins at step 216 whereby testing occurs on a larger scale such as a selected geographic region before full production of the product takes place. Once again, if the sampling reveals deficiencies, further refinements take place at step 218 and the process repeats itself. Once acceptable, large volume scale sampling takes place at step 220 which includes full production of the product for mass marketing. At this point, only minor changes to specifications should occur at 222 to avoid incurring any associated high manufacturing costs. The final product is established as complete at step 224. Throughout this production cycle, relevant data provided by various sources are collected and stored for re-use in further developments on behalf of the customer or even different customers of product development enterprise 150. This data collection is indicated in FIG. 2 as steps 202, 206, 210, 214, 218 and 222 and reflects opportunities occurring throughout the product development cycle for product development targeting. This data helps product developers better understand their rolling targets during the design and execution at product development stages.

The Product specification and development application standardizes and simplifies the process of exchanging product specification information with product developers, enabling the product development enterprise to quickly evaluate the information. This process enhances productivity, provides reduced time-to-market for final items, and lower costs of final products.

Having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into the executed by a computer, the computer becomes an apparatus for practicing the invention. When implemented on a general-purpose microprocessor, the computer program code segments configure the microprocessor to create specific logic circuits.

What is claimed is:

1. A method for facilitating product development processes within a multi-enterprise environment via a computer network, said multi-enterprise environment including a product development enterprise and at least one customer enterprise, comprising:
providing access to a web site of said product development enterprise by said at least one customer enterprise via said computer network;
providing access to an account maintained on behalf of said customer enterprise;
receiving data inputs pertaining to a product development request, said product development request originating from said customer enterprise;
storing said data inputs in a data storage device;
extracting said data inputs for review and analysis;
establishing a product development plan in response to said review and said analysis;
executing said product development plan;
wherein said product development enterprise is running a product specification and development application for implementing said product development processes.

2. The method of claim 1, further comprising:
receiving data inputs pertaining to said product development plan, wherein said inputs are provided by a research and development organization.

3. The method of claim 1, further comprising:
receiving data inputs pertaining to said product development plan, wherein said inputs are provided by a marketing enterprise.

4. The method of claim 2, wherein said inputs provided by said research and development organization include:
new process technology;
new applications for existing properties of a product or product element; and
industry standards pertaining to a product or process.

5. The method of claim 3, wherein said inputs provided by said marketing enterprise include:
new trends in consumer behavior;
economic or market conditions influencing said consumer behavior; and
competitor analyses.

6. The method of claim 1, wherein said data inputs include product specifications.

7. The method of claim 1, wherein said data inputs include product specification changes.

8. The method of claim 1, wherein said data inputs include process technology changes.

9. The method of claim 1, wherein said data inputs are received at a plurality of points throughout a product development cycle.

10. The method of claim 1, wherein said extracting said data inputs occurs at a plurality of points throughout a product development cycle.

11. The method of claim 1, wherein said extracting said data inputs for said review and analysis causes refinements to be made in said product development plan.

12. The method of claim 1, wherein said customer enterprise is a supplier.

13. The method of claim 1, wherein said customer enterprise is a manufacturer.

14. A system for facilitating product development processes within a multi-enterprise environment via a computer network, said multi-enterprise environment including:
a product development enterprise, comprising:
a server located on a host system;
at least one terminal;
a data storage device; and
a network for allowing said host system, said at least one terminal, and said data storage device to communicate;
at least one customer enterprise, comprising:
a server;
at least one terminal;
a network for allowing said terminal and said server to communicate; and
a communications network for allowing said at least one customer enterprise to communicate with said product development enterprise;
wherein said product development enterprise is executing a product specification and development application.

15. The system of claim 14, wherein said product development enterprise:
receives data inputs from said at least one customer enterprise; and
executes said product specification and development application; wherein said data inputs are collected and analyzed by said product specification and development application;
develop and implement a product development plan based upon said results of execution of said product specification and development application.

16. The system of claim 15, wherein said product development plan is refined based upon results of further execution of said product specification and development application.

17. The system of claim 14, wherein said data inputs are received throughout a product development cycle.

18. The system of claim 14, wherein said at least one customer enterprise is a trading partner of said product development enterprise.

19. The system of claim 14, wherein said at least one customer enterprise is a research organization.

20. A storage medium encoded with machine-readable computer program code for facilitating product development processes within a multi-enterprise environment via a computer network, said multi-enterprise environment including a product development enterprise and at least one customer enterprise, the storage medium including instructions for causing a computer to implement a method comprising:
providing access to a web site of said product development enterprise by said at least one customer enterprise via said computer network;
providing access to an account maintained on behalf of said customer enterprise;
receiving data inputs pertaining to a product development request, said product development request originating from said customer enterprise;
storing said data inputs in a data storage device;
extracting said data inputs for review and analysis;
establishing a product development plan in response to said review and said analysis;
executing said product development plan;
wherein said product development enterprise is running a product specification and development application for implementing said product development processes.

21. The storage medium of claim 20, further comprising instructions for causing a computer to implement:
receiving data inputs pertaining to said product development plan, wherein said inputs are provided by a research and development organization.

22. The storage medium of claim 20, further comprising instructions for causing a computer to implement:
receiving data inputs pertaining to said product development plan, wherein said inputs are provided by a marketing enterprise.

23. The storage medium of claim 21, wherein said inputs provided by said research and development organization include:
new process technology;
new applications for existing properties of a product or product element; and
industry standards pertaining to a product or process.

24. The storage medium of claim 22, wherein said inputs provided by said marketing enterprise include:
new trends in consumer behavior;
economic or market conditions influencing said consumer behavior; and
competitor analyses.

25. The storage medium of claim 20, wherein said data inputs include product specifications.

26. The storage medium of claim 20, wherein said data inputs include product specification changes.

27. The storage medium of claim 20, wherein said data inputs include process technology changes.

28. The storage medium of claim 20, wherein said data inputs are received at a plurality of points throughout a product development cycle.

29. The storage medium of claim 20, wherein said extracting said data inputs occurs at a plurality of points throughout a product development cycle.

30. The storage medium of claim 20, wherein said extracting said data inputs for said review and analysis causes refinements to be made in said product development plan.

31. The storage medium of claim 20, wherein said customer enterprise is a supplier.

32. The storage medium of claim 20, wherein said customer enterprise is a manufacturer.
